(19) United States
(12) Patent Application Publication
(10) Pub. No.: US 2024/0412517 A1
(43) Pub. Date: Dec. 12, 2024

(54) SPECIFIC BEHAVIOR DETECTING DEVICE, METHOD AND PROGRAM

(71) Applicant: NIPPON TELEGRAPH AND TELEPHONE CORPORATION, Tokyo (JP)

(72) Inventors: Motohiro TAKAGI, Tokyo (JP); Shigekuni KONDO, Tokyo (JP); Yushi AONO, Tokyo (JP)

(73) Assignee: NIPPON TELEGRAPH AND TELEPHONE CORPORATION, Tokyo (JP)

(21) Appl. No.: 18/717,429

(22) PCT Filed: Dec. 15, 2021
(86) PCT No.: PCT/JP2021/046298

§ 371 Date: Jun. 7, 2024

(51) Int. Cl. G06V 20/52; G06V 10/62; G06V 10/74; G06V 10/86; G06V 20/40

(52) U.S. Cl. CPC G06V 20/52; G06V 10/62; G06V 10/761; G06V 10/86; G06V 20/46

(57) ABSTRACT

Video data obtained by imaging a target region is acquired, and a partial region video including at least a detection target object is detected from a frame of the acquired video data. Then, feature information indicating a feature of a motion of the object is extracted from a plurality of the partial region videos detected in a first section for each first section including a plurality of frames, and first behavior feature information is generated by structuring the plurality of pieces of extracted feature information in a second section. Subsequently, a cost reflecting similarity between the generated first behavior feature information and each of a plurality of pieces of second behavior feature information related to the object prepared in advance is calculated, the second behavior feature information in which the calculated cost satisfies a preset condition is detected as search behavior information, and the detected search behavior information is output.

### TECHNICAL FIELD

One embodiment of the present invention relates to a specific behavior detection device, method and program for detecting a specific behavior of a person from media data such as video data.

### BACKGROUND ART

In recent years, various techniques for analyzing behaviors of people based on captured videos have been proposed as more and more high-definition cameras are used. For example, there are techniques for detecting crime behaviors or abnormal behaviors at construction sites based on images of surveillance cameras.

Incidentally, in order to detect behaviors of people with high accuracy, it is necessary to observe a large number of videos. In this case, since manual detection is time-consuming and labor-intensive, techniques using algorithms for automatically detecting abnormal behaviors have been studied. For example, there are techniques for detecting abnormal behaviors with high accuracy by clustering videos using neural networks. However, in such types of techniques which have been proposed at present, sufficient identification performance cannot be obtained when rare abnormal behaviors are detected from a large number of normal behaviors. In addition, there are many scenes in which it is unknown which behaviors are actually the abnormal behaviors, and there are cases in which it is difficult to label normal and abnormal behaviors.

Accordingly, for example, as disclosed in NPL 1, a technique in which a user is allowed to designate an abnormal behavior as a query and the abnormal behavior is detected by using the designated query has been proposed.

### CITATION LIST

### Non Patent Literature

[NPL 1] D. Dwibedi et al. “Temporal Cycle Consistency Learning”. CVPR2019.

### SUMMARY OF INVENTION

### Technical Problem

Incidentally, in the technique described in NPL 1, without taking temporal features of actions of people into consideration, all frames of a video are taken into consideration, in other words, abnormal behaviors are detected, with no features that are extracted from the frames of the video being omitted. Therefore, when a length of a query video is short and the video is long, a calculation cost becomes very large.

The present invention has been made focusing on the foregoing circumstances, and an object of the present invention is to provide a technique capable of detecting a specific behavior in consideration of a temporal structure of a behavior feature of a person while curbing calculation costs.

### Solution to Problem

To solve the foregoing problem, according to an aspect of the present invention, a specific behavior detection device includes: a first processing unit configured to acquire video data obtained by imaging a target region; a second processing unit configured to detect a partial region video including at least a detection target object from a frame of the acquired video data; a third processing unit configured to extract feature information indicating a feature of a motion of the object from a plurality of the partial region videos detected in a first section for each first section including a plurality of frames and to generate first behavior feature information by structuring the plurality of pieces of extracted feature information in a second section; a fourth processing unit configured to calculate a cost, in which similarity between the generated first behavior feature information and each of a plurality of pieces of second behavior feature information related to the object prepared in advance is reflected, and to detect the second behavior feature information, in which the calculated cost satisfies a preset condition, as search behavior information; and a fifth processing unit configured to output the detected search behavior information.

According to another aspect of the present invention, for example, search processing of behavior feature information of a person is performed by comparing the first behavior feature information structured with the section of a plurality of frames as a unit with a plurality of pieces of second behavior feature information prepared in advance. Therefore, a time required for the search processing can be greatly shortened in comparison with a case where the behavior feature information of the person shown in each frame of the video data is compared with the search target feature information for each time, and a processing load of the specific behavior detection device required for the search processing can be reduced.

### Advantageous Effects of Invention

That is, according to an aspect of the present invention, it is possible to provide a technique capable of detecting a specific behavior in consideration of a temporal structure of an action feature of a person while curbing calculation costs.

### BRIEF DESCRIPTION OF DRAWINGS

FIG. 1 is a block diagram illustrating an example of a hardware configuration of a specific behavior detection device according to a first embodiment of the present invention along with a configuration of peripheral devices.

FIG. 2 is a block diagram illustrating an example of a software configuration of the specific behavior detection device according to the first embodiment of the present invention.

FIG. 3 is a flowchart illustrating an example of a processing procedure and processing content of specific behavior detection processing executed by a control unit of the specific behavior detection device illustrated in FIG. 2.

FIG. 4 is a flowchart illustrating a processing procedure and processing content of behavior feature extraction processing in the specific behavior detection processing illustrated in FIG. 3.

FIG. 5 is a flowchart illustrating an example of a processing procedure and processing content of behavior search processing in the specific behavior detection processing illustrated in FIG. 3.

FIG. 6 is a flowchart illustrating an example of a processing procedure and processing content of search behavior ranking processing in the specific behavior detection processing illustrated in FIG. 3.

### DESCRIPTION OF EMBODIMENTS

Hereinafter, embodiments of the present invention will be described with reference to the drawings.

### First Embodiment

### Configuration Example

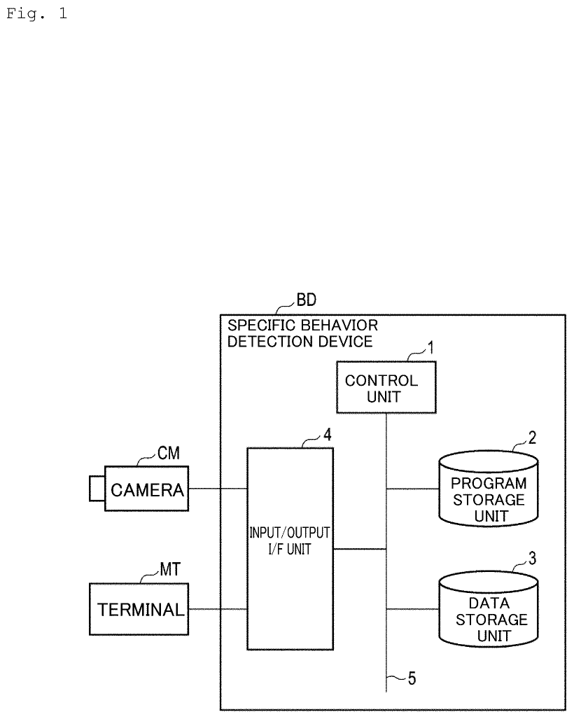

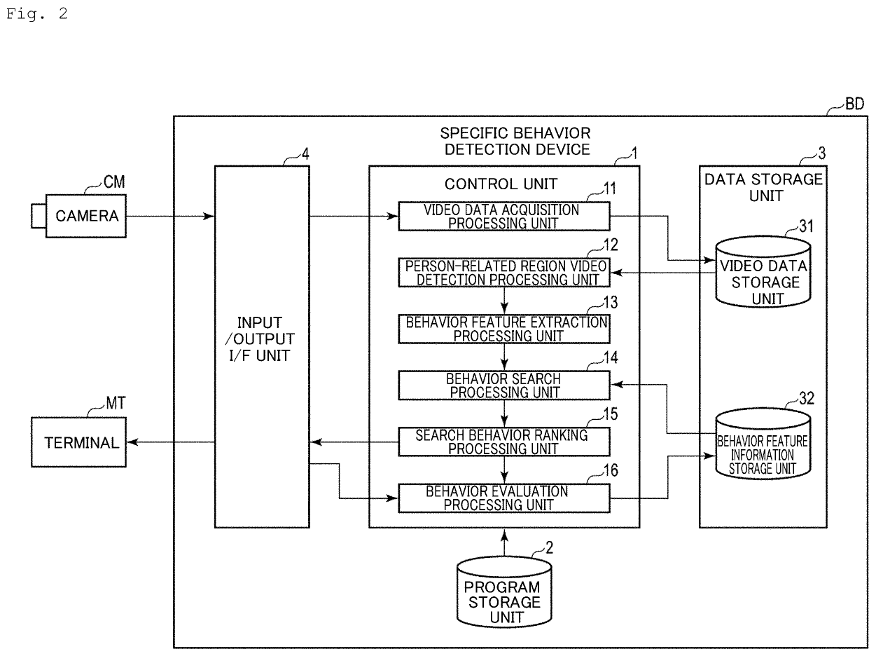

FIG. 1 is a block diagram illustrating an example of a hardware configuration of a specific behavior detection device according to a first embodiment of the present invention along with a configuration of peripheral devices. FIG. 2 is a block diagram illustrating an example of a software configuration of the specific behavior detection device.

The specific behavior detection device BD is configured with an information processing device such as a server computer or a personal computer. A camera CM and a terminal MT are connected to the specific behavior detection device BD via a signal cable or a network (not illustrated).

The camera CM is installed, for example, on a ceiling, a wall surface, or the like capable of imaging a monitoring target area, images the whole body or a part of a detection target person who is located in or intrudes into the monitoring target area together with its peripheral area, and transmits time-series video data to the specific behavior detection device BD.

Although the video data captured by the camera CM may be transmitted directly from the camera CM to the specific behavior detection device BD, the video data may be temporarily stored in a video database (not illustrated) and then transmitted to the specific behavior detection device BD. The number of cameras CM is not limited to one, and may be a plural.

The terminal MT is used by, for example, a system manager or a monitoring person who monitors a specific behavior of the person, and is configured with an information processing terminal such as a personal computer. The terminal MT has a function for receiving and displaying detection information of a specific behavior output from, for example, the specific behavior detection device BD. The terminal MT may have a function of inputting training data necessary for training the machine training model to the specific behavior detection device BD when the specific behavior detection device BD includes a machine training model.

The specific behavior detection device BD includes a control unit 1 using a hardware processor such as a central processing unit (CPU) or an image processing unit (GPU). A storage unit including a program storage unit 2 and a data storage unit 3, and an input/output interface (hereinafter abbreviated to as an I/F) unit 4 are connected to the control unit 1 via a bus 5. The control unit 1 may be configured using a programmable logic device (PLD), a field programmable gate array (FPGA), or the like.

The input/output I/F unit 4 has a communication interface function, and transmits and receives video data and input/output data to and from the camera CM and the terminal MT via a signal cable or a network.

The program storage unit 2 is obtained by, for example, combining a nonvolatile memory such as a solid state drive (SSD) capable of performing writing and reading frequently and a nonvolatile memory such as a read-only memory (ROM) serving as a storage medium and stores application programs necessary to perform various types of control processing according to the first embodiment in addition to middleware such as an operating system (OS). Hereinafter, the OS and each application program are collectively referred to as a program.

The data storage unit 3 includes a video data storage unit 31 and a behavior feature information storage unit 32 as main storage units necessary to carry out the first embodiment, for example, by combining a non-volatile memory such as an SSD capable of performing writing and reading at any time and a volatile memory such as a random access memory (RAN) as a storage medium.

The video data storage unit 31 is used to temporarily store time-series video data transmitted from the camera CM for specific behavior detection processing.

The behavior feature information storage unit 32 stores information indicating features of a plurality of specific behaviors that a detection target person can take as a reference behavior feature information group.

The control unit 1 includes a video data acquisition processing unit 11, a person-related region video detection processing unit 12, a behavior feature extraction processing unit 13, a behavior search processing unit 14, a search behavior ranking processing unit 15, and a behavior evaluation processing unit 16 as processing functions necessary to carry out the first embodiment. Each of the processing units 11 to 16 is implemented by causing a hardware processor of the control unit 1 to execute an application program stored in the program storage unit 2.

The video data acquisition processing unit 11 performs processing for acquiring the time-series video data output from the camera CM via the input/output I/F unit 4 and temporarily storing the acquired video data in the video data storage unit 31.

The person-related region video detection processing unit 12 outputs person-related region video information indicating a class and a position of a person shown in the frame image by the machine training model by reading video data from the video data storage unit 31 for each frame and inputting a frame image of the video data to an object detection model trained in advance.

The behavior feature extraction processing unit 13 inputs the person-related region video information output from the person-related region video detection processing unit 12 to a previously trained action recognition model. Then, the action recognition model extracts a feature vector related to a motion of the person corresponding to the person-related region video group included in a segment for each segment in which a plurality of frames are collected as one unit. Then, the extracted behavior vector group of the person is output as temporally structured behavior feature information. The processing for extracting the person feature information will be described in more detail in an action example.

The behavior search processing unit 14 receives the extracted behavior feature information from the behavior feature extraction processing unit 13 and reads a reference behavior feature information group associated with the detection target person from the behavior feature information storage unit 32. Then, the behavior search processing unit 14 compares the extracted behavior feature information with each piece of reference behavior feature information included in the read reference behavior feature information group, calculates a replacement cost of an intermediate node, includes the reference behavior feature information in which the calculated replacement cost satisfies a predetermined condition in the search behavior information, and outputs the search behavior information This behavior search processing will be described in more detail in an action example.

The search behavior ranking processing unit 15 inputs search behavior information output from the behavior search processing unit 14 to a ranking model trained in advance. Then, the search behavior information ranked, for example, in a replacement cost order by a ranking model is output.

The behavior evaluation processing unit 16 obtains an evaluation value of a search result based on the search behavior information ranked by the search behavior ranking processing unit 15, and performs processing for updating the reference behavior feature information stored in the behavior feature information storage unit 32 based on the evaluation value and the evaluation value input by a user.

The machine training model used in the person-related region video detection processing unit 12, the behavior feature extraction processing unit 13, the behavior search processing unit 14, and the search behavior ranking processing unit 15 is configured with, for example, a convolutional neural network, but a type of neural network can be appropriately selected and used.

### Operation Example

Next, an operation example of the specific behavior detection device BD that has the above-described configuration will be described.

The machine training model used in the person-related region video detection processing unit 12, the behavior feature extraction processing unit 13, the behavior search processing unit 14, and the search behavior ranking processing unit 15 is assumed to be trained in advance in the following description.

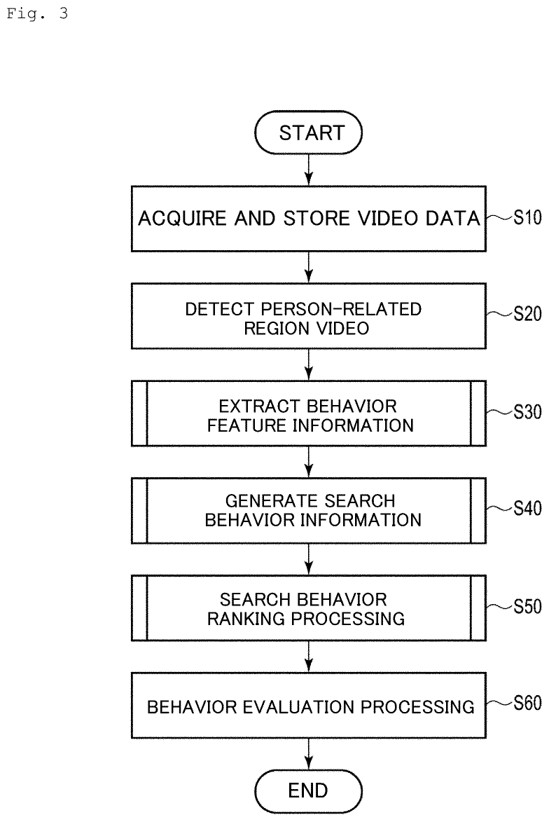

FIG. 3 is a flowchart illustrating an example of a processing procedure and processing content of the entire specific behavior detection processing executed by the control unit 1 of the specific behavior detection device BD.

### (1) Acquiring Video Data

Under the control of the video data acquisition processing unit 11, a control unit 1 of the specific behavior detection device BD acquires time-series video data obtained by imaging a monitoring target area by the camera CM via the input/output I/F unit 4 in step S10. Then, the acquired video data is temporarily stored in the video data storage unit 31.

### (2) Detecting Person-Related Region Video

When the video data is acquired for a fixed time, the control unit 1 of the specific behavior detection device BD performs processing for detecting a video of a person-related region from the video data in step S20 under the control of the person-related region video detection processing unit 12 as follows.

That is, the person-related region video detection processing unit 12 reads the video data from the video data storage unit 31 for each frame, and inputs a frame image of the read video data to the object detection model. Then, information indicating a class and a position of a person shown in the frame image is acquired by the object detection model.

For example, the person-related region video detection processing unit 12 detects a video section in which the person is shown from each frame image of the video data, and cuts out a region in which the person is shown for each person by using a person tracking scheme. When the same person is detected continuously for a certain section, person-related region video information to which a person ID for identifying the person is given is output.

### (3) Extracting Behavior Feature Information

The control unit 1 of the specific behavior detection device BD extracts a feature of a behavior of the person from the person-related region video information under the control of the behavior feature extraction processing unit 13 in step S30.

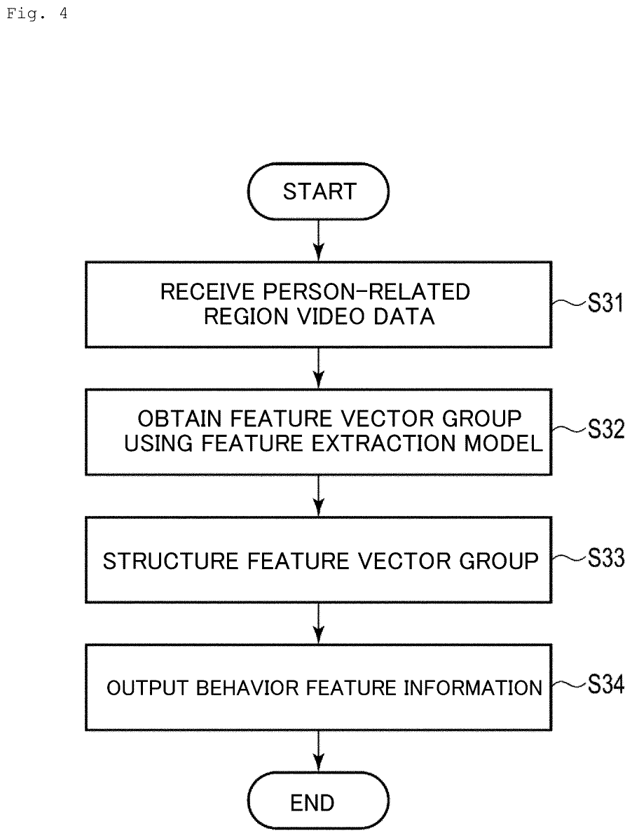

FIG. 4 is a flowchart illustrating an example of the processing procedure and the processing content of the behavior feature extraction processing performed by the behavior feature extraction processing unit 13.

That is, the behavior feature extraction processing unit 13 receives the person-related region video information from the person-related region video detection processing unit 12 in step S31. Then, in step S32, the received person-related region video information is input to the trained action recognition model. The action recognition model collects a plurality of frames of the person-related region video information into one segment, and extracts a feature vector which is a feature related to a motion of a person corresponding to a person-related region video group included in the segment for each segment.

For example, the behavior feature extraction processing unit 13 collects 32 frames into one segment and extracts feature vectors from a person-related region video group of the 32 frames. As a result, a feature vector corresponding to a person-related region video group of one segment related to the same person is extracted. That is, information indicating the feature of a motion of the person in the section of the 32 frames is extracted for each person through this processing.

The behavior feature extraction processing unit 13 generates behavior feature information by temporally structuring the feature vector group extracted for each person in step S33.

Here, the structuring is performed to construct a graph U in a predetermined section T with regard to feature vector groups (u_1, u_2, . . . , u_N) of a certain person. Here, T corresponds to the number of nodes in the graph, and one node corresponds to a feature vector u_i. Although an example of a complete graph is taken as the graph, links may be reduced as necessary. Here, the number of nodes T is determined in advance.

The behavior feature extraction processing unit 13 outputs the temporally structured behavior feature information U to the behavior search processing unit 14 in step S34.

### (4) Generating Search Behavior Information

The control unit 1 of the specific behavior detection device BD subsequently performs processing for searching for a behavior of the person under the control of the behavior search processing unit 14 as follows in step S40.

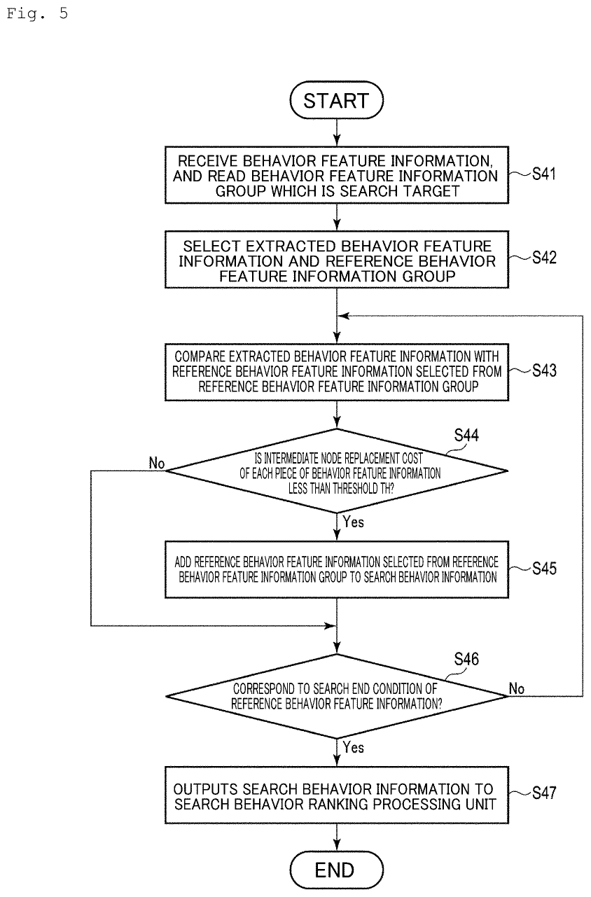

FIG. 5 is a flowchart illustrating an example of a processing procedure and processing content of the behavior search processing performed by the behavior search processing unit 14.

That is, in step S41, the behavior search processing unit 14 first receives the behavior feature information from the behavior feature extraction processing unit 13 and reads a reference behavior feature information group corresponding to the same person from the behavior feature information storage unit 32. Then, the behavior search processing unit 14 selects one piece of reference behavior feature information from the reference behavior feature information group in step S42, and compares the selected reference behavior feature information with the extracted behavior feature information in step S43. Then, the replacement cost of the intermediate node between both between the pieces of information is evaluated.

For example, when U is the extracted behavior feature information and V is the selected reference behavior feature information, the behavior search processing unit 14 replaces intermediate nodes u_{T/2} and v_{T/2} of both between the pieces of information. Then, as a base point of the intermediate node, cosine similarity between v_{T/2} and each node u_j excluding u_{T/2} is calculated, and a sum C_{uv} of the cosine similarity is calculated. On the other hand, cosine similarity between the above v_{T/2} and each node v_j excluding v_{I/2} is calculated in advance, and a sum C_v is held. Then, the behavior search processing unit 14 calculates a difference between the sums C_{uv} and C_v, and sets a calculated difference value as the replacement cost.

Another index may be used as long as the index can determine the similarity of the graph structures, for example, the comparison between C_{vu} and C_u which are reverse patterns of the replacement cost. A cosine similarity s between u_{T/2} and v_{T/2} may be combined. According to this scheme, a calculation cost can be reduced by a scheme such as comparison with only a graph with the high cosine similarity s without performing calculation of all the graphs.

The replacement cost is not limited to T/2. For example, nodes located at positions of T/2+1 and T/2−1 are set as base points, and calculation may be performed by taking a sum, a weighted sum, or the like.

When the replacement cost of the intermediate node is calculated, the behavior search processing unit 14 compares the replacement cost with a preset threshold TH in step S44 to determine whether the replacement cost is less than the threshold TH. When the replacement cost is less than the threshold TH as a result of the determination, the reference behavior feature information V which is a comparison target is added to the search behavior information in step S45.

The behavior search processing unit 14 determines, in step S46, whether a search end condition for the reference behavior feature information is satisfied. For example, it is determined whether the comparison processing with all the reference behavior feature information has been completed. When the unselected reference behavior feature information remains as a result of the determination, the processing returns to step S43 to select subsequent reference behavior feature information, and processing of steps S43 to S46 is performed on the selected reference behavior feature information.

Thereafter, similarly, the behavior search processing unit 14 repeatedly performs the processing of steps S43 to S46 in sequence on each unselected reference behavior feature information. When the processing ends on all the reference behavior feature information, the behavior search processing unit 14 moves to step S47 and outputs the finally obtained search behavior information to the search behavior ranking processing unit 15.

Before the search processing for the behavior feature information, v_{T/2} may be clustered for the reference behavior feature information group to construct the centroid c_k of v. In this way, hierarchical search processing can be performed such that each piece of reference behavior feature information v_i is searched for from search of a centroid c_k.

The cost of the centroid c_k is set to, for example, an average of the costs of the reference behavior feature information v_i belonging to the centroid c_k. In this case, the centroid c_k is compared with the cost c_{cu} when the centroid c_k is replaced with the intermediate node u_{T/2} of the extracted behavior feature information. When a cost compared with the centroid c_k is greater than the threshold as a result of the comparison, the comparison processing with other nodes is omitted, and the search processing ends.

### (5) Ranking Search Behavior

The control unit 1 of the specific behavior detection device BD subsequently performs ranking on the search behavior information under the control of the search behavior ranking processing unit 15 in step S50.

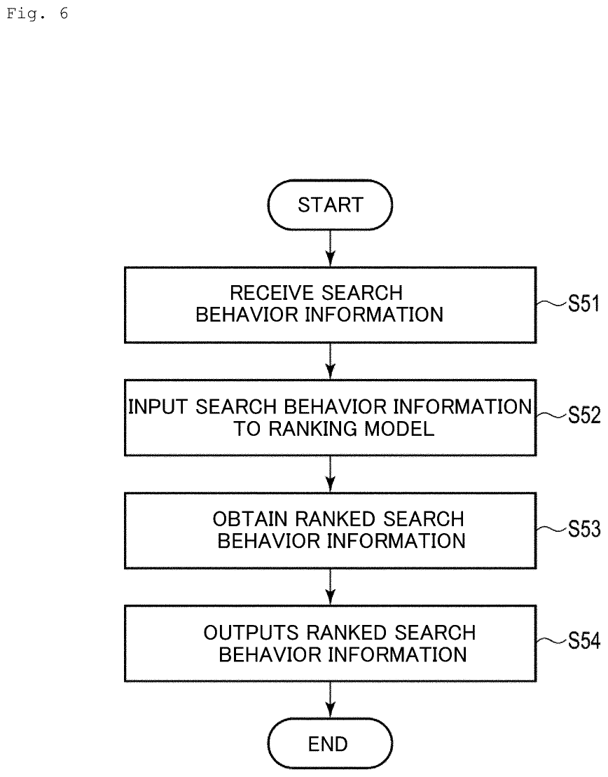

FIG. 6 is a flowchart illustrating an example of a processing procedure and processing content of the search behavior ranking processing performed by the search behavior ranking processing unit 15.

That is, the search behavior ranking processing unit 15 first receives the search behavior information from the behavior search processing unit 14 in step S51. Subsequently, in step S52, the received search behavior information is input to the ranking model. Then, in step S53, the search behavior information ranked, for example, in the replacement cost order by the ranking model is output, and the ranked search behavior information is output from the input/output I/F unit 4 to the terminal MT in step S54.

The ranking model may be constructed in any way as long as the ranking model determines an order in which the search results are displayed. For example, cost differences may be arranged in an ascending order, or a model constructed to output ranking evaluation values using ranking training or the like may be used.

The search behavior ranking processing unit 15 gives the ranked search behavior information to the behavior evaluation processing unit 16. The behavior evaluation processing unit 16 obtains an evaluation value of the search result based on the ranked search behavior information and updates the reference behavior feature information stored in the behavior feature information storage unit 32 based on the evaluation value.

### Operations and Effects

As described above, according to the first embodiment, based on the video of the region where the same person detected for each frame of the video data is shown, the behavior feature extraction processing unit 13 first extracts, for each segment including a plurality of frames, a vector indicating a feature of a motion of a person in the section of the plurality of frames, and temporally constructs the graph U corresponding to the predetermined section T on the extracted feature vector group, and thus constructs the feature vector group temporally. Subsequently, the behavior search processing unit 14 compares the structured extracted behavior feature information with each of the plurality of pieces of reference behavior feature information of the corresponding person stored in the behavior feature information storage unit 32, calculates the replacement cost of the intermediate node between both between the pieces of information, sets the reference behavior feature information of which the calculated replacement cost is less than the threshold TH as the search behavior information. Finally, the search behavior ranking processing unit 15 ranks and outputs each piece of reference behavior feature information included in the search behavior information in, for example, the replacement cost order.

Accordingly, according to the first embodiment, the search processing of the behavior feature information of the person is performed by comparing the extracted behavior feature information structured in units of sections of the plurality of frames with the plurality of pieces of reference behavior feature information. Therefore, a time required for the search processing can be greatly shortened in comparison with a case where the behavior feature information of the person shown in each frame of the video data is compared with the reference behavior feature information for each frame, and a processing load of the specific behavior detection device required for the search processing can be reduced. That is, the calculation cost required for the search processing of the specific behavior detection device can be inhibited.

### Second Embodiment

In a second embodiment of the present invention, in a person-related region video, a specific portion which remarkably indicates a motion of a person and a peripheral region of the specific portion are detected as a target, and a feature of a behavior of the person is extracted based on the detected person-related region video. In the embodiment, the drawings used in the first embodiment are cited as they are in description.

That is, the person-related region video detection processing unit 12 detects a rectangular region including a hand and an object operated by the hand as a person-related region video by focusing on, for example, the hand as a part remarkably indicating a motion of a detection target person. The behavior feature extraction processing unit 13 collects a plurality of frames and inputs the rectangular region to an action recognition model, obtains motion feature vectors of the hand and the object operated by the hand, and forms behavior feature information using the feature vectors.

It is desirable to obtain temporal consistency between the hand of the same person when the rectangular region is detected. For example, when a position of the hand at time t+1 is within a fixed distance from the position of the hand at time t, the hand is regarded as the hand of the same person. The behavior feature information may be configured by holding both a feature vector configured by a region of the whole person and a feature vector configured by the region including the hand and the object operated by the hand as one node. At this time, an operation such as weighted sum, connection, and addition may be performed on the behavior feature information.

### Third Embodiment

In the foregoing first embodiment, a condition that the replacement cost less than the threshold TH is added to the search behavior information in the behavior search processing unit 14 is set. Conversely, in the third embodiment, a rare abnormal behavior of the person is detected by performing the search on condition that the replacement cost is greater than the threshold. In the third embodiment, the drawings used in the first embodiment are cited in description.

When U is the extracted behavior feature information and V is the selected reference behavior feature information, the behavior search processing unit 14 replaces intermediate nodes u_{T/2} and v_{T/2} of both between the pieces of information.

Then, cosine similarity between v_{T/2} and each node u_j excluding u_{T/2} as a base point of the intermediate node is calculated, and the sum c_{UV} of the cosine similarity is calculated. On the other hand, the cosine similarity with each node v_j excluding the foregoing v_{T/2} and v_{i/2} is calculated in advance, and the sum C_v is held. Then, the behavior search processing unit 14 calculates a difference between the sum C_{uv} and C_v, and sets the calculated difference value as a replacement cost.

The replacement cost is not limited to T/2. For example, nodes at positions of T/2+1 and T/2−1 are used as base points, and the calculation may be performed by taking a sum, a weighted sum, or the like.

When the replacement cost of the intermediate node is calculated, the behavior search processing unit 14 compares the replacement cost with a preset threshold TH2 and determines whether the replacement cost is greater than the threshold TH2. When the replacement cost is greater than the threshold TH2 as a result of the determination, the reference behavior feature information V which is a comparison target is added to the search behavior information.

Before the search processing of the behavior feature information, v_{T/2} is clustered for a reference behavior feature information group to construct the centroid c_k of v. When hierarchical search processing is performed, centroid c_k is compared with the cost C_{cu} in the replacement with the intermediate node u_{T/2} of the extracted behavior feature information. When the cost compared with the centroid c_k is less than the threshold as a result of the comparison, the comparison processing with other nodes is omitted, and the search processing ends.

### Other Embodiments

In the foregoing first embodiment, the case in which the function of the specific behavior detection device BD is provided in an information processing device such as a server computer or a personal computer provided independently of the camera CM and the terminal MT has been described as an example. However, the present invention is not limited thereto. Some or all of the functions of the specific behavior detection device BD may be provided in the camera CM and the terminal MT.

Although the first embodiment has been described as an example of the case where a specific behavior of a person is detected, the detection target is not limited to a person but may be an animal, a robot, or the like. In addition, various modifications of the type or configuration of specific behavior detection device, and the processing procedures and the processing content of each processing unit can be implemented within the scope of the gist of the present invention.

Although the embodiments of the present invention have been described in detail above, the above description is merely examples of the present invention in all respects. It goes without saying that various modifications and variations can be made without departing from the scope of the invention. That is, a specific configuration according to an embodiment may be appropriately adopted in implementing the present invention.

In short, the present invention is not limited by the above described embodiments as it is and can be embodied by modifying constituents without departing from the gist and scope of the invention in implementation stages. Various inventions can be implemented by suitably combining a plurality of constituents disclosed in the above-described embodiments. For example, some constituents may be deleted from all the constituents described in the embodiments. Furthermore, constituents of different embodiments may be combined as appropriate.

### REFERENCE SIGNS LIST

BD Specific behavior detection device
CM Camera
MT Terminal
1 Control unit
2 Program storage unit
3 Data storage unit
4 Input/output I/F unit
5 Bus
11 Video data acquisition processing unit
12 Person-related region video detection processing unit
13 Behavior feature extraction processing unit
14 Behavior search processing unit
15 Search behavior ranking processing unit
16 Behavior evaluation processing unit
31 Video data storage unit
32 Behavior feature information storage unit

1. A specific behavior detection device, comprising:
first processing circuitry configured to acquire video data obtained by imaging a target region;
second processing circuitry configured to detect a partial region video including at least a detection target object from a frame of the acquired video data;
third processing circuitry configured to extract feature information indicating a feature of a motion of the object from a plurality of the partial region videos detected in a first section for each first section including a plurality of frames and to generate first behavior feature information by structuring the plurality of pieces of extracted feature information in a second section;
fourth processing circuitry configured to calculate a cost, in which similarity between the generated first behavior feature information and each of a plurality of pieces of second behavior feature information related to the object prepared in advance is reflected, and to detect the second behavior feature information, in which the calculated cost satisfies a preset condition, as search behavior information; and
fifth processing circuitry configured to output the detected search behavior information.

2. The specific behavior detection device according to claim 1, wherein:
the second processing circuitry detects, as the partial region video, a video of a region including an action portion of the detection target object and a peripheral object in which the action portion is an operation target.

3. The specific behavior detection device according to claim 1, wherein:
the third processing circuitry structures the plurality of pieces of feature information by constructing a graph in which the plurality of pieces of extracted feature information are respectively allocated to the number of nodes corresponding to the second section.

4. The specific behavior detection device according to claim 3, wherein the fourth processing circuitry is further configured to perform:
processing for replacing a first intermediate node and a second intermediate node with each other between the first behavior feature information and each of the plurality of pieces of second behavior feature information,
processing for calculating first similarity information indicating a sum of similarities between the replaced second or first intermediate node and each of other nodes of the first or second behavior feature information,
processing for calculating second similarity information indicating a sum of similarities between the second or first intermediate node of the second or first behavior feature information and each of other nodes of the second or first behavior feature information,
processing for calculating a difference between the first similarity information and the second similarity information as a replacement cost, and
processing for detecting the second behavior feature information, in which the replacement cost satisfies the preset condition, as the search behavior information.

5. The specific behavior detection device according to claim 1, wherein:
the fourth processing circuitry compares the cost with a preset threshold, and detects the second behavior feature information, the cost of which is less than the threshold or the second behavior feature information, the cost of which is greater than the threshold as the search behavior information.

6. The specific behavior detection device according to claim 1, wherein:
the fifth processing circuitry performs ranking of the search behavior information, based on the cost.

7. A specific behavior detection method, comprising:
acquiring video data obtained by imaging a target region;
detecting a partial region video including at least a detection target object from a frame of the acquired video data;
extracting each piece of feature information indicating a feature of a motion of the object from a plurality of the partial region videos detected in a first section for each first section including a plurality of frames and generating first behavior feature information by structuring the plurality of pieces of extracted feature information in a second section;
calculating a cost, in which similarity between the generated first behavior feature information and each of a plurality of pieces of second behavior feature information related to the object prepared in advance is reflected, and detecting the second behavior feature information, in which the calculated cost satisfies a preset condition, as search behavior information; and
outputting the detected search behavior information.

8. A non-transitory computer readable medium storing a program for causing a processor to perform the method of claim 7.
